(19) United States
(12) Patent Application Publication
(10) Pub. No.: US 2011/0246266 A1
(43) Pub. Date: Oct. 6, 2011

(54) MALL-SPACE COMMERCIAL PROMOTION

(75) Inventors: Melvin M. White, Oregon City, OR (US); Kevin B. Carty, Portland, OR (US); Jay E. Fetherston, Portland, OR (US); Christopher James, Portland, OR (US)

(73) Assignee: RG Marketing, LLC, Portland, OR (US)

(21) Appl. No.: 13/052,066

(22) Filed: Mar. 19, 2011

Related U.S. Application Data
(60) Provisional application No. 61/341,669, filed on Apr. 2, 2010.

(51) Int. Cl. G06Q 30/00

(52) U.S. Cl. 705/14.4

(57) ABSTRACT

A computer-and-network-based, commercial promotion system, and an associated methodology, employable in an indoor or outdoor population space which is occupiable by potential consumers. The methodology features (a) creating a clearly discernible, substantially continuous-action, dynamical, commercial-expression attractor characterized by a presentation flow of time-changing, seriatim-subject, commercial-aspect content-expression attractor components, (b) in functional relation to such creating, suitably furnishing, in the space, a potential-consumer content-interaction site, and (c) at that site, freely enabling consumer-implemented site dedication to offering specific, focused communication interaction with at least one consumer-selected, content-expression attractor component which is then included in the attractor presentation flow, without such site dedication disturbing that flow.

### CROSS REFERENCE TO RELATED APPLICATION

This application claims filing-date priority to U.S. Provisional Patent Application Ser. No. 61/341,669, filed Apr. 2, 2010, for “In-Mall, Commercial Promotion”, the entire disclosure content of which is hereby incorporated herein by reference.

### BACKGROUND AND SUMMARY OF THE INVENTION

The present invention pertains, from both systemic and methodologic points of view, to an electronic-network, computer-based, commercial advertising/informational promotion practice which is aimed at capturing the focused attentions of potential consumers, also referred to herein simply as consumers—typically pedestrians, people in wheel chairs, etc., referred to collectively herein as pedestrians—who are present in, i.e., who occupy, a selected, indoor or outdoor space which we refer to variously as a population space, as a mall space, as a setting, as a gathering and/or meeting space, as an outdoor “pedestrian-only street-style” space, and as a mall-space volume, or volume, of space. Throughout the description of the invention, we will principally, though not always, refer to such space simply as “mall space”, with the understanding that this term is intended to embrace all of the just-above-mentioned, several “space” characterizations.

In a “mall space”, or in any indoor or outdoor gathering and/or meeting space, including even certain, outdoor, “pedestrian-only street-style” spaces, there is usually present an ever-changing body of pedestrian, etc. consumer, or potential consumer, traffic flowing in one or more mall-space area(s), such as a concourse, or concourses, which areas are also referred to herein as consumer occupiable, commercial-direction regions. Regarding this “commercial-direction region” reference, the phrase “commercial-direction” is intentionally employed in order to emphasize the fact that such a region may be thought of as having a certain spatial directionality, with respect to which will be found region-occupying consumers who may readily be attracted by the commercial promotion activity which is proposed by the present invention. Accordingly, commercial-directionality relative to mall space is a “consumer sightline” feature which is taken into account in and by the system and methodology of the invention, and specifically is taken into account in relation to the “aiming”, visually, and with sound (if appropriate), of the invention's proposed practice involving mall-space broadcasting of commercial promotional-content attractor material.

Accordingly, the invention envisions the placement within mall space, at an appropriate site, or at plural appropriate sites, therein—which, for non-exhaustive example, might be a single site (or plural, spaced sites) located within a simple, linear concourse, or at the location(s) of one or more concourse-intersection hubs involving two or more concourses, or centrally in a large open space, of appropriately faceted, such as plural-faceted (i.e., two-, three-, or four-faceted) computer-and-network-based kiosk-like, consumer-engagement structures, referred to herein also as facet structures, and as potential-consumer content-interaction sites.

In relation to each such facet structure, there is created for facet-structure-associated broadcasting, under appropriate computer control, and preferably essentially continuously into the adjacent mall-space volume of space, what is effectively an appropriate-commercial-directionality, such as “swirling” (revolving, rotating, moving spatially in time-sequence, etc.), projected-into-the-surrounding-mall-space (or volume as just mentioned), at least visual advertising/commercial-promotion attractor display—a plural-component-content-advertising, or plural-component-content-promotional, flow—of provider-sourced (and provider paid for), commercial advertising and/or commercial informational content which is selectively and freely changeable over time in accordance with payment and display arrangements made with different, commercial-content providers.

This content which, of any relevant nature, is referred to herein under the identities of “advertising material”, “advertising-flow content”, “promotional content”, “promotional-content components”, etc., is not necessarily, though it could be, “stored” in a memory at the location of the relevant facet structure. Rather, it flows preferably, and substantially continuously and dynamically, at least throughout a selected time period, to a facet-structure-associated, display-presentation projection structure via a communication network, such as the Internet. The projected, or most typically “visu-cast” (a special term created herein for use in the present invention disclosure), seriatim-changing advertising content presentation continuously reaches all potential customer view lines extending into the surrounding mall space, and specifically into the relevant, adjacent, “consumer occupiable, commercial-direction regions”, effectively operating as an attractor inviting mall-space occupants to “come to the facet-structure” for a more in-depth “look and see”. It will be understood that content components in such a presented flow may well be structured to offer information at different levels, including at the level of “teasers” which encourage potential consumers to seek and probe for more information in a manner associated with consumer content-communication interaction (text, image, and verbal and nonverbal dialogue) at the site of a relevant, associated facet. This “probe” encouragement and enablement, as will become appreciated, is one of the important aspects of the present invention.

It should be understood that “content” considered herein for recognition as being potentially included in the presented (projected) attractor-display-flow may come from a wide variety of provider sources, not necessarily limited simply to parties who are direct providers of commercial goods and services. For example such content, regarding any appropriate, selected topic, may be supplied by parties engaged in the field of news media, such as in the field of newspaper media. Accordingly, the concepts of commercial content and of promotional content expressed herein are intended to include these kinds of providers.

Each facet-structure facet “aims” into the key mall-space spatial regions in the surrounding mall volume, i.e., into the above-mentioned, consumer occupiable, commercial-direction regions, and defines, within the associated facet structure, an independent space, or zone, or engagement site, wherein a mall-space occupant is encouraged to singulate, and to look selectively more intently, and interactively electronically, at a selected content portion, or at plural, selected content portions, of the continuously presented, commercial-content display. These portions are made at least temporarily dedicatedly facet-available specifically, and interactively (through a computer interface, such as a web browser), “at the call”, and preferably under the complete control, of an interested mall occupant who has entered the facet zone, and are displayed within and at the location of that facet. Selection by a mall occupant for such specific, commercial-content interactivity within a facet is independent of what goes on in every other facet, and has no effect on the content or behavior of the basic, full-content, mall-space projected attractor display.

A mall-space occupant entering the zone of a facet, and whose personal presence, and even under some circumstances identity, within the zone may, if desired, be positively signaled in some fashion for various reasons, is therewithin given an opportunity, through a provided network, such as Internet, connection, to select and singulate for interactive reviewing and probing, dedicatedly, one, or sequentially more than one, of the specific content components of the advertising material flow which continues to be displayed as a time continuum (as previously explained) to all who can view the related facet structure in the mall space, per se. Probing enablement contemplates allowing a facet-occupying consumer to “dig, below” the surface qualities of attractor-display-presentation content components, at many levels if desired, to gain in-depth, related content information.

Consumer “interaction” within a facet zone is referred to herein as stabilized, facet-zone-dedicated, consumer communication (such communication including the possibility of “live” or “non-live” text dialogue) interaction, and may take any appropriate form, such as (a) interaction at various probing levels with electronically network-communicated provider content information, (b) direct interactive communication with an automated or real person (such as a provider representative or provider-representative surrogate), (c) receipt of a “coupon”, or “coupons”, for various discount, promotional, etc. purposes, and (d) other interesting and useful forms. Live dialogue capability may include real, person-to-person discussion, or person-to-“computer-voice” discussion; text dialogue is what it is as is well understood in the computer and network communication world.

It should be clearly understood that the action of a particular consumer customer entering the zone of a facet, and selecting, a particular advertising-content component for in-depth review, does not in any way affect either the basic, full-content, broadcast attractor display which remains flowing as a continuum to all who can see it in the nearby mall space, and also does not affect the possibility for another consumer customer to enter the zone of another, adjacent facet to make the same, or a different, independent content selection for interactive review.

Herein, with regard to attracted-consumer “engagement” within a facet zone, lies one of the very important and special aspects of the present invention. Specifically, the invention features a practice and a behavior, wherein a peopled-space area, which may be a very broadly distributed area, receives a highly discernible, visual, and possibly also audible, broadcast presentation of a seriatim display of advertising and promotional commercial content provided by various content offerors—this broadcast being done in association with a kiosk-like facet structure that, uniquely, has a kind of “universal quality”, which is that, and this is one important way of operating the invention, this facet structure is not initially dedicated or committed to presenting just the promotional material of any one of the display content providers. In other words, the kiosk-like facet structure may be thought of as being something in the nature of a “blank slate” regarding which interactively-available information, based upon what is then being presented in the continuous people-attractor display, may, essentially solely by consumer action, rather than by content provider action, become presentingly dedicated for a period of time chosen by that consumer for various-level interaction with consumer-selected content. In other words, practice of the present invention does not lead a consumer from a broad-region broadcast promotional display to specific and particular, provider-individual sites that are pre-dedicated to the offerings of just one of the several providers who are then sourcing the broadcast promotional attractor content. And so, the kiosk facet structures proposed for use in accordance with practice of the invention become, in a consumer-instantiated way, interactively operative with respect only to consumer-selected (not provider-selected) broadcast content—essentially completely under the control and selection of a consumer who decides to implement content interaction.

Thus, and from a structural/systemic point of view, the present invention proposes a computer-based, commercial promotion system for use in a defined mall-space having at least one consumer-occupiable commercial-direction region, with this system including (a) a system source for receiving and for furnishing, throughout a selected time period, a controllably and selectively modifiable, continuity advertising-flow of visually-presentable commercial attractor advertising material which is characterized by plural, promotional-content components that are furnished by selected, advertising-content providers, (b) commercial-direction-region presentation projection structure, operatively connected to the system source, operable to create, within the entirety of the at least one commercial-direction region, and for viewing by mall-space consumers occupying that region, a projected attractor display-presentation of full-content advertising-flow material, (c) consumer-accessible facet structure operatively associated with the defined mall space, as well as with the advertising-flow system source and the projection structure, including at least one commercial-direction-region, regionally-exposed facet, and for the at least one facet, an associated consumer selection zone which is electively enterable by a mall-space consumer, and (d) within that zone, consumer-interactive computer-communication structure operatively associated with the advertising-flow, and including advertising-flow-interaction structure enabling, completely under consumer control, associated, zone-independent, projection-noninterruptive, consumer selection of, and stabilized, facet-zone-dedicated, consumer communication interaction with, one or more of the content components in the attractor advertising flow.

Methodologically, the invention contemplates, in an indoor or outdoor population space which is occupiable by potential consumers, (a) creating a clearly discernible, substantially continuous-action, dynamical, commercial-expression, or content-expression, attractor characterized by a presentation flow of time-changing, seriatim-subject, commercial-aspect content-expression attractor components, (b) in functional relation to such creating, suitably furnishing in the space a potential-consumer content-interaction site, and (c) at that site, freely enabling consumer-implemented site dedication to offering specific, focused communication interaction with at least one consumer-selected, content-expression attractor component which is then included in the attractor presentation flow, without such site dedication disturbing that flow.

From another methodologic point of view, the invention, operating in a mall-space setting, and using network-connected computer structure, includes (a) projecting to mall-space consumers a substantially continuous display of different-provider-source, network-furnished commercial advertising content organized as provider-source-based components, (b) in association with such projecting, furnishing plural (or at least one), mall-space-consumer, display-component-interaction facet(s), and (c) at each facet, enabling a mall-space consumer, independently, and without interrupting continuity in the projected display, to interact selectively and at will, and dedicatedly with one or more, of the advertising content provider-source-based components.

From still a further methodologic perspective, the invention features an electronic and communication-network-supported commercial promotion method for selectively singulating, for visual and other interactive depth review, a chosen content portion of a stream of at least visu-cast, plural-content-element, commercial information, including the steps of (a) multidirectionally at least visu-casting such a stream into a randomly and changeably person-populated volume of space, (b) using such visu-casting, attracting a person in the space to an engageable singulation site disposed in the space, and (c) enabling a so-attracted person, at the singulation site location, electronically and networkingly, to make, and engage interactively with, a depth-review, dedicated singulation of and from the attracting, visu-cast content stream without interrupting the flow of the stream.

These and other systemic and methodologic features of the invention will become more fully apparent as the detailed description of it which is presented below is read in conjunction with the accompanying drawings.

### DESCRIPTIONS OF THE DRAWINGS

FIG. 1 is a stylized and simplified, fragmentary, high-level schematic drawing, principally possessing a plan-view format, illustrating a computer-based, commercial promotion system and methodology pictured as being implemented in a representative, conventional, concourse-and-hub mall space in accordance with a preferred and best mode embodiment of, and manner of practicing, the present invention. The illustrated mall space shown is one including three, angularly intersecting, consumer pedestrian concourses which come together at a hub.

FIG. 2 is an isometric, representative illustration of a kiosk-like facet structure employable in the system, and for practicing the methodology, of the invention, as such is illustrated schematically in FIG. 1.

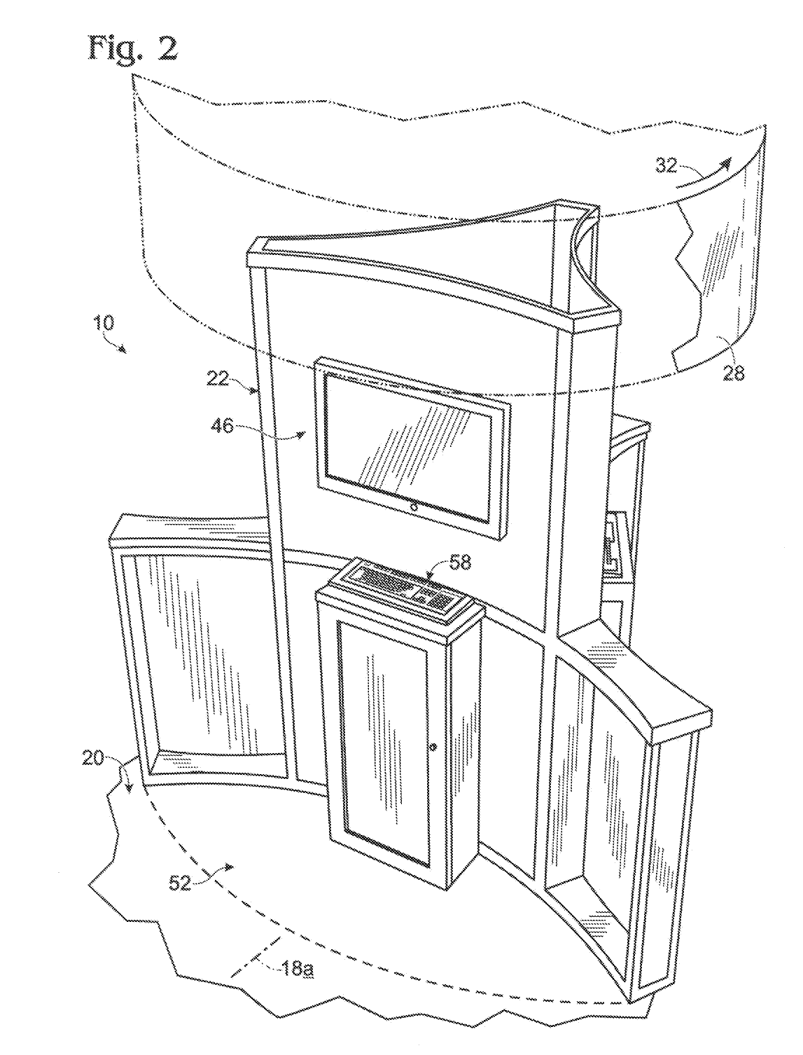

FIG. 3 is a top plan view of the facet structure pictured in FIG. 2.

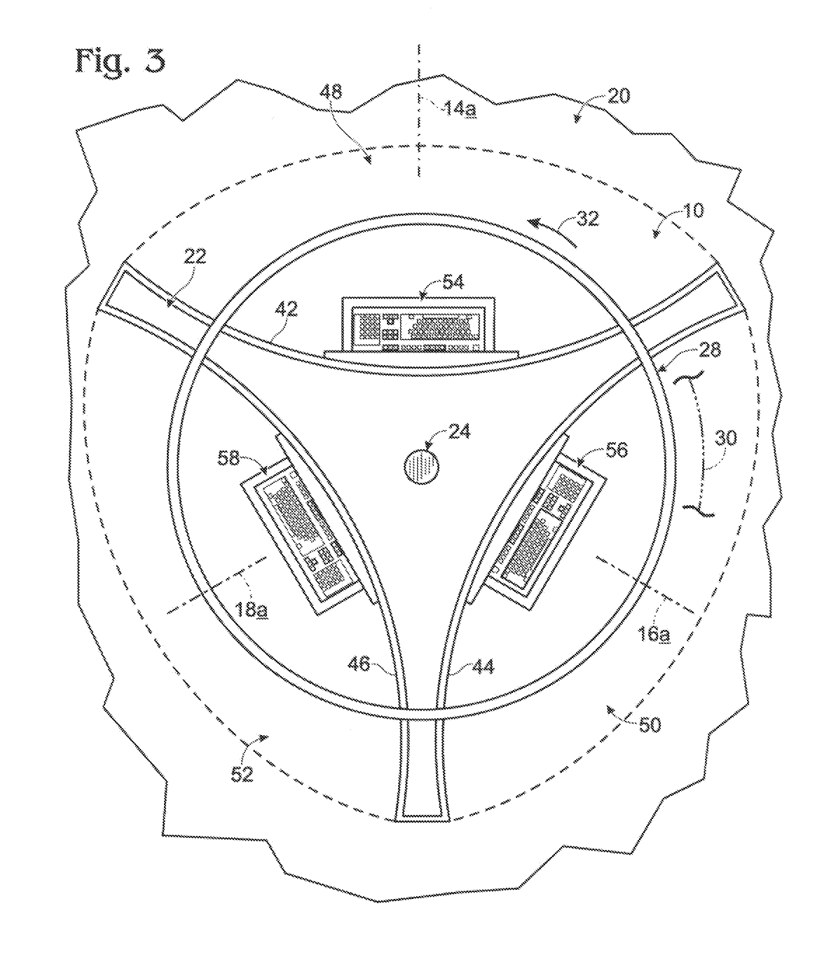

### DETAILED DESCRIPTION OF THE INVENTION

Turning now to the drawings, indicated generally at 10 is a mall-space, commercial promotion system which is made in accordance with a preferred and best-mode embodiment of the present invention. System 10, as shown in the drawing figures, is presented in the setting of a fragmentarily illustrated, representational, conventional, commercial, indoor mall space 12 which is pictured herein as including three, elongate, angularity intersecting, pedestrian-consumer concourses, or consumer-occupiable, commercial-direction regions, 14, 16, 18. These three regions intersect at, and radiate outwardly from, a central hub 20. The notion of “commercial directionality” which is associated, in a naming sense, as just mentioned, with regions 14, 16, 18, in relation to features of the present invention, pertains generally to the respective directionalities of the long axes, 14a, 16a, 18a, of these regions—these axes being represented by respective, dash-dot lines. Commercial directionality may have other specific kinds of relationships with other forms of mall space, as is outlined generally above in the Background and Summary of the Invention.

Regions 14, 16, 18, and hub 20, each constitutes individually, and constitute collectively, what is referred to herein as a volume of space within mall space 12.

It should be understood at this point that, while a particular, representative, indoor mall space, including the specifically illustrated, three, commercial-direction regions, or concourses, 14, 16, 18 which meet at a hub, has been chosen as a setting in which to describe the present invention, the system of the invention may readily be deployed, and its associated methodology practiced, in various, other kinds of mall spaces, including, for examples, (a) those that include different kinds of concourse-intersecting hubs, (b) spaces which may be defined with only singular elongate concourses, and (c) outdoor street spaces dedicated to pedestrian-only traffic, to name just a few. Other representative kinds of spaces wherein the invention offers utility were outlined earlier herein.

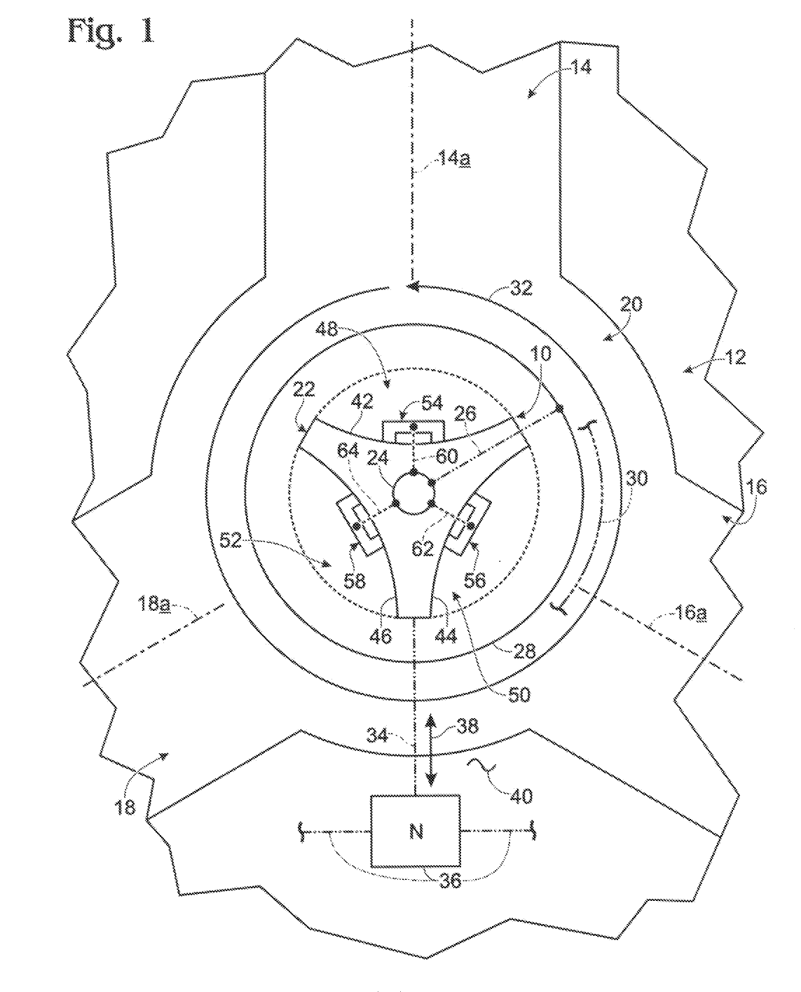

Continuing now with what is shown in the drawings, system 10 includes a kiosk-like structure 22, also referred to herein as a kiosk, as a facet structure, as a potential-consumer content-interaction site, and as an engageable singulation site, placed, as can be seen in FIG. 1, substantially centrally within hub 20.

Included within, and/or otherwise operatively associated, with, facet structure 22, as a part of system 10, are a digital-computer-based system source 24 for receiving, and for furnishing for viewing (and for other purposes soon to be explained), throughout a selected time period, a controllably and selectively modifiable, continuity advertising-flow of visually presentable, different-provider, commercial advertising/promotional attractor material which is characterized, preferably, by plural, provider-source-based, promotional-content components that are furnished, as will be explained shortly, by different, selected, advertising-content providers. This flow is also referred to herein as a discernible, substantially continuous-action, dynamical, commercial-expression attractor characterized by a presentation flow of time-changing, seriatim-subject, commercial-aspect content-expression attractor components.

The concept of advertising-flow continuity is intended to refer herein to a continuous data stream of flow-contained, seriatim, advertising-content, promotional components which is maintained throughout the mentioned selected time period—a time period which essentially, though not necessarily, preferably matches the “open-for-business” (or open for other peopled activities, i.e., meetings, gatherings, etc.) hours of the associated mall space.

In system 10 as it is now being described, system source 24 is appropriately data-flow communicatively connected, as shown by a dash-double-dot line 26, to what is referred to herein as a commercial-direction-region, presentation projection structure 28—an “attractor” presenter. Projection structure 28, which sits preferably laterally centrally, and relatively high, above facet structure 22, and which is pictured herein in the illustrated and representative embodiment of the invention as being substantially annular in configuration, takes the form of a suitable, conventional, digitally-driven display screen. This screen functions preferably to create, and to project, or present, or “visu-cast” (i.e., without accompanying sound), from the advertising-flow of promotional content sent to it, as will be further discussed, from system source 24, an “all-regionally-adjacent-mall-space” motion-display presentation—referred to as an attractor, and represented schematically in FIG. 1 by a short, fragmentary, curved, dash-triple-dot line 30 which is drawn in this figure closely adjacent the radially outer side of a small portion of the curvature of screen 28.

As a reminder, the term “visu-cast”, employed herein as above, has been constructed to point out that, preferably, and perhaps in most instances, the visual motion attractor display which is created by display screen 28 is, effectively, projected to all surrounding mall space (an “all-mall-space” presentation) within which a consumer pedestrian, etc., has a view line to the screen, without any accompanying sound. Reference, therefore, to presentation, or projection, of the mentioned advertising-flow of promotional material is thus referred to herein occasionally as being at least visu-cast into the volume of space which includes, of course with respect to system 10 as it has been described so far, hub 20, and the several, commercial-direction regions defined by concourses 14, 16, 18. Naturally, in order that the visu-cast advertising-flow of material will be discerned easily by consumers in the relevant surrounding space, it is important that the projection-structure screen, 28, be positioned high enough above facet structure 22 to be easily viewable.

In the particular setting of the mall space which is illustrated and discussed herein, we have found it to be preferable, though not necessary, that screen 28, and the presented advertising-flow of promotional material, effectively operate and present with a kind of unidirectionally-circular, continuous, swirling motion, “traveling” at an appropriate readability pace. Such motion is indicated generally in FIG. 1 by a curved arrow 32 which circumsurrounds facet structure 22.

Other types of appropriate display-screen structures/configurations, as attractor presenters, and related styles of presentation, may, of course, be employed if desired, recognizing that promotional-material projection/presentation, preferably, should be directed into all, relevant-commercial-direction, mall-space regions.

System source 24, in addition to having the previously mentioned, operative, data-flow communication connection 26 to (and with) display screen 28, further includes an appropriate connection, represented by a dash-double-dot line 34, to an extensive electronic communication network, such as the Internet, represented by a block (internally labeled N), and a pair of laterally extending, fragmentarily shown, dash-double-dot lines connected to this block, all designated 36. Network connection 34, in relation to system source 24 and network 36, accommodates appropriate bidirectional communication. Such communication includes, preferably, both (a) the inputting (to, and for system-internal “to-facet” and “to-screen-28” furnishing” by, source 24) of advertising-flow promotional attractor material, and (b) the “outbound/inbound” consumer-interactive, within-facet communicating, as will shortly be more fully described, between a consumer in mall-space 12 and advertising-flow content material.

This quality and capability of bidirectional communication via connection 34 is illustrated schematically in FIG. 1 by a short, double-arrow-headed line 38. A small, serpentine-shaped, wave-like line 40 in FIG. 1 schematically represents the fact that, over time, and selectively and modifiability at will by a manager of system 10, changes may be made in the specific content of the advertising-flow promotional attractor material.

Focusing attention now more specifically on facet structure 22, and on things and matters associated therewith, structure 22, as illustrated herein, includes three, “regionally-exposed”, display-component-interaction facets 42, 44, 46 which directly face previously mentioned concourses, or commercial-direction regions, 14, 16, 18, respectively, along the central axes of these regions. Associated with facets 42, 44, 46, and indicated by curved, boundary-marking dashed lines, are three zones 48, 50, 52, respectively, which are referred to herein both as consumer-selection zones, and as engageable singulation sites.

Associated connectively and communicatively with system source 24 and with facet structure 22, and disposed, one each, within consumer-selection zones 48 50, 52, are three, conventional, computer-interactive, computer-communication structures, including advertising-flow-interaction structures, 54, 56, 58, respectively, which feature appropriate user-interaction interfaces, such as keyboards and display screens (one or more), enabling, inter alia, direct mall-consumer interaction with the ongoing advertising flow of promotional material presented on screen 28. Appropriate, operative, data-communication connections, bidirectional in nature, are shown by dotted-end, dash-double-dot lines 60, 62, 64 in FIG. 1 that are pictured directly connecting system source 24 with interaction structures 54, 56, 58, respectively, and thereby also connecting these interaction structures, through the system source, both with the ongoing screen-displayed advertising-flow of promotional attractor material, and with network 36.

Specifically what is permitted a mall consumer by these communication and user-interaction structures, significantly, is selective consumer-determined singulation, and thereby completely consumer-controlled (as distinguished from promotional-content-provider controlled) dedication, of a particular facet, for focused attention to, and dedicated interaction with, a selected attractor component (or more than one such attractor component over time) in the body of seriatim advertising-flow material. Such singulation interaction, in accordance with practice of the present invention, and as has been discussed earlier herein, occurs in a manner which neither (a) interrupts the ongoing attractor presentation which is made available throughout the mentioned, commercial-direction viewing regions that are nearby in mall-space 12, nor (b) affects similar types of consumer singulating-interactions which may take place in conjunction with consumers engaged within the other illustrated, two consumer selection zones.

With system 10 possessing the features just described, the invention, operating in a mall-space setting such as that pictured as mall space 12, and using network-connected computer structure, methodologically involves (a) creating a clearly discernible, substantially continuous-action, dynamical, commercial-expression attractor characterized by a presentation flow of time-changing, seriatim-subject, commercial-aspect content-expression attractor components, (b) in functional relation to such creating, suitably furnishing, in the space, a potential-consumer content-interaction site, and (c) at that site, freely enabling consumer-implemented site dedication to offering specific, focused communication interaction with at least one consumer-selected, content-expression attractor component which is then included in the attractor presentation flow, without such site dedication disturbing that flow.

From another perspective, the invention methodology may be expressed as (a) projecting, or visu-casting, to mall-space consumers a substantially continuous display of different-provider-source, network-furnished commercial advertising/promotion content organized as provider-source-based components, (b) in association with such projecting, furnishing plural (or at least one), mall-space-consumer, display-component-interaction facet(s), and (c) at each facet, enabling a mall-space consumer, independently, and without interrupting continuity in the general, mall-space projected display, to interact selectively and at will with one or more, of the advertising content, provider-source-based components.

From still a further methodologic point of view, the invention also features an electronic and communication-network-supported commercial promotion method for selectively singulating, for visual and other interactive depth review, a chosen content portion of a stream of at least visu-cast, plural-content-element, commercial information, including (a) multidirectionally at least visu-casting such a stream into a randomly and changeably person-populated volume of space, (b) using such visu-casting, attracting a person in the space to an engageable singulation site disposed in the space, and (c) enabling a so-attracted person, at the singulation site location, electronically and networkingly, to make, and engage interactively with, a depth-review, dedicated singulation of and from the attracting, visu-cast content stream without interrupting the flow of the stream.

It should be noted that, while, in the illustration of the system of the invention presented so herein, the facet structure includes simply one facet aimed toward each of the three, illustrated commercial-direction regions in mall-space 12, a modified form of the invention may readily incorporate plural facets so (or otherwise) aimed. The number of facets is not limited by any characteristic feature of the present invention.

It should also be noted that, while already mentioned, the concept of visu-casting expressed at certain points herein is one which rests preferably on the presentation of visual information only, i.e., without accompanying sound, and even if no sound is presented which is associated specifically with the visu-cast display that is projected generally into the mall space per se, it is entirely possible, if desired, to include, specifically within each facet-associated consumer selection zone, an appropriate, zone-specific audio system, such as a downward-direction audio “down-sound” system. Such an audio system would enable a consumer within that zone to experience both sight and sound interaction with advertising promotion material, without this zone-specific sound behavior in any way affecting the sound conditions of either adjacent facets, or the outer mall-space, per se.

As was mentioned, and illustratively outlined earlier herein, there is a very large range of styles of interaction which may be permitted a consumer engaged in an interaction process within one of the facet zones.

Accordingly, while a preferred and best-mode embodiment of, and manner of practicing the invention, and certain possible modifications thereof, have been illustrated and/or described herein, other variations and modifications are certainly possible without departing from the spirit of the invention, as claimed.

We claim:

1. In an indoor or outdoor population space which is occupiable by potential consumers,
creating a clearly discernible, substantially continuous-action, dynamical, commercial-expression attractor characterized by a presentation flow of time-changing, seriatim-subject, commercial-aspect content-expression attractor components,
in functional relation to said creating, suitably furnishing in the space a potential-consumer content-interaction site, and
at that site, freely enabling consumer-implemented site dedication to offering specific, focused communication interaction with at least one consumer-selected, content-expression attractor component which is then included in the attractor presentation flow, without such site dedication disturbing that flow.

2. In a setting occupiable by potential consumers, and using network-connected computer structure, a methodology comprising
projecting into that setting a substantially continuous, consumer-attracting display of different-provider, network-furnished commercial promotional content organized as provider-based components,
in association with said projecting, furnishing plural, consumer-approachable, display-component-interaction, commercial-promotion facets, and
at each such facet, enabling a consumer who has been attracted to the facet, independently, and in a manner then, at least temporarily, consumer-dedicating the content-promotional character of the facet, and without interrupting continuity in the projected display, to interact selectively, communicatively and at will with one or more, of the advertising content provider-based components.

3. The methodology of claim 2, wherein said enabling includes facilitating computer network-based interaction between a mall-space consumer and a component provider.

4. An electronic and communication-network-supported commercial promotion method for selectively singulating, for visual and other interactive review, a chosen content portion of a stream of at least visu-cast, plural-content-element, commercial information, said method comprising
multidirectionally at least visu-casting such a stream into a randomly and changeably person-populated volume of space,
using said visu-casting, attracting a person in the space to an engageable singulation site disposed in the space, and
enabling a so-attracted person, at the singulation site location, electronically and networkingly, to make, and engage interactively with, a focused-review, dedicated singulation of and from the attracting, visu-cast content stream without interrupting the flow of the stream.

5. A computer-based, commercial promotion system for use in a defined mall-space having at least one consumer-occupiable commercial-direction region, comprising
a system source for receiving, and for furnishing, throughout a selected time period, a controllably and selectively modifiable, continuity advertising-flow of visually-presentable commercial advertising material which is characterized by plural, promotional-content components that are furnished, by selected, advertising-content providers,
commercial-direction-region presentation projection structure, operatively connected to said system source, operable to create, within the entirety of said at least one commercial-direction region, and for viewing by mall-space consumers occupying that region, a projected display-presentation of full-content advertising-flow material,
consumer-accessible facet structure operatively associated with the defined mall space, as well as with said advertising-flow system source and said projection structure, including at least one commercial-direction-region, regionally-exposed facet, and for said at least one facet, an associated consumer selection zone which is electively enterable by a mall-space consumer, and
within said zone, consumer-interactive, computer-communication structure operatively associated with the advertising-flow, and including advertising-flow-interaction structure enabling, completely under consumer control, associated, zone-independent, projection-noninterruptive, consumer selection of, and stabilized, facet-zone-dedicated, consumer communication interaction with, one or more of the content components in the advertising flow.

6. The system of claim 5, wherein enabled consumer communication interaction with advertising-flow content components includes enabled consumer dialogue interaction with such components.

7. The system of claim 5, wherein said system source and said consumer-interactive computer-communication structure are operatively connected for communication with an electronic network, such as the Internet.

8. The system of claim 7, wherein the advertising-flow content is supplied to said system source for projection through, and is freely download-modifiable via, the mentioned electronic network.

9. The system of claim 5 which, more specifically, is for use in a defined mall-space of the type having plural, consumer occupiable, commercial-direction regions generally radiating from a mall-space hub, and wherein said projection structure is designed and operable to create, for viewing by mall-space consumers occupying all of said regions, the mentioned display-presentation of full-content advertising-flow material, said facet structure is located at the mall-space hub, and includes, for each commercial-direction-region, at least one regionally-exposed facet, and for each said facet, an associated consumer selection zone which is electively enterable by a mall-space consumer, with each said zone possessing consumer-interactive computer-communication structure operatively associated with the advertising-flow, and including advertising-flow-interaction structure enabling associated, zone-independent, projection-noninterruptive, consumer selection of, and stabilized communication interaction with, one or more of the content components in the advertising flow.

10. The system of claim 9, wherein said projection structure possesses a configuration for creating, regarding the advertising-flow content, a motion display of that content effectively swirling visually around the mall-space hub.
